(19) United States
(12) Patent Application Publication
(10) Pub. No.: US 2010/0318514 A1
(43) Pub. Date: Dec. 16, 2010

(54) CONTENT PLAYBACK DEVICE AND PROGRAM

(76) Inventor: Tatsuya Mitsugi, Tokyo (JP)

Correspondence Address: BIRCH STEWART KOLASCH & BIRCH, PO BOX 747, FALLS CHURCH, VA, 22040-0747, US

(21) Appl. No.: 12/864,587

(22) PCT Filed: Feb. 19, 2009
(86) PCT No.: PCT/JP2009/000704

§ 371 Date: Jul. 26, 2010

(30) Foreign Application Priority Data
Apr. 23, 2008 (JP) 2008-112778

(51) Int. Cl. G06F 17/30

(52) U.S. Cl. 707/722; 707/E17.044

(57) ABSTRACT

A content playback device selects a region of pieces of additional information of contents to be played back in a random order in an order list 3, sets pieces of item information of additional information to be arranged in the order list 3 in the random order within the set region of pieces of additional information, and arranges the pieces of additional information in the order list 3 in a random playback order on the basis of the pieces of item information set within the above-mentioned region of pieces of additional information so as to play back content data recorded into recording media 5.

### FIELD OF THE INVENTION

The present invention relates to a content playback device that reads content data, such as data about a musical piece, from a recording medium to play back the content data, and a program that causes a computer to operate as this content playback device.

### BACKGROUND OF THE INVENTION

As a related art content playback device, there is an automatic playing device disclosed by, for example, patent reference 1. In this device, a directory structure is formed as the data holding structure of a storage means, a plurality of music data each showing a musical piece, and playback order data showing the order of playback of a plurality of music data are stored in one directory, and the plurality of music data are played back in the order specified by the playback order data.

Furthermore, a music playback device having a facilitated registration process of registering playback order data is disclosed by patent reference 2. Playlist data defining the playback order of music data handled by this music playback device are comprised of item data each corresponding to music data, and the item data are comprised of number data, check mark data, etc. The music data are played back in the playback order defined by the number data of the item data, and the user is enabled to register whether or not each music data can be played back by simply specifying corresponding check mark data presented for the user via a display.

[Patent reference 1] JP,2001-109470,A
[Patent reference 2] JP,2006-196058,A

A problem with related art devices is that in the case of handling content data recorded into different types of recording media, such as a CD (Compact Disc), a USB (Universal Serial Bus), and a hard disk drive, they cannot set any random playback order while setting desired music data as objects to be played back without being aware of the types of recording media.

For example, the content playback device disclosed by patent reference 1 plays back music data stored in one directory in the order defined by the playback order data, but does not take into consideration music data recorded into different types of recording media. Furthermore, the content playback device disclosed by patent reference 2 cannot systematically carryout control of the playback order of music data recorded into different types of recording media.

The present invention is made in order to solve the above-mentioned problems, and it is therefore an object of the present invention to provide a content playback device that can control playback of content data, such as musical pieces, in a random order without being aware of a plurality of types of recording media by handling the plurality of types of recording media systematically, and a program that causes a computer to operate as this content playback device.

### DESCRIPTION OF THE INVENTION

In accordance with the present invention, there is provided a content playback device including: a database creating means for extracting pieces of additional information each for specifying a content from a plurality of types of recording media in which content data and the additional information for specifying the content are recorded to create a content database in which path information showing a recording place of the above-mentioned additional information and the above-mentioned content data is registered for each content; a region setting means for selecting a region of pieces of additional information of contents to be played back in a random order in an order list in which the pieces of additional information extracted from the above-mentioned content database are listed; an object setting means for setting pieces of item information of the above-mentioned pieces of additional information which are to be arranged in the above-mentioned order list in the random order within the above-mentioned region of pieces of additional information set by the above-mentioned region setting means; an order creating means for arranging the above-mentioned pieces of additional information in the above-mentioned order list in the random playback order within the above-mentioned region of pieces of additional information set by the above-mentioned region setting means on a basis of the pieces of item information set by the above-mentioned object setting means; and a content playback means for playing back content data recorded in the above-mentioned recording media in the playback order of the above-mentioned order list on a basis of path information acquired from the above-mentioned content database.

The content playback device in accordance with the present invention selects a region of pieces of additional information of contents to be played back in a random order in the order list, sets pieces of item information of additional information to be arranged in the order list in the random order within the set region of pieces of additional information, and arranges the pieces of additional information in the order list in a random playback order on the basis of the pieces of item information set within the above-mentioned region of pieces of additional information so as to play back content data recorded into the recording media. By doing in this way, the content playback device in accordance with the present invention can systematically handle the plural types of recording media, and can control the playback of content data, such as musical pieces, in a random order without being aware of the types of recording media.

### BRIEF DESCRIPTION OF THE FIGURES

FIG. 1 is a block diagram showing the configuration of a content playback device in accordance with Embodiment 1 of the present invention;

FIG. 2 is a view showing an example of the configuration of a musical piece database shown in FIG. 1;

FIG. 3 is a view showing an example of the configuration of a track table;

FIG. 4 is a view showing an example of the configuration of a track name table.

FIG. 5 is a view showing an example of the configuration of an artist name table.

FIG. 6 is a view showing an example of the configuration of a playlist name table.

FIG. 7 is a view showing an example of the configuration of a folder table.

FIG. 8 is a view showing a hierarchical relationship among folders;

FIG. 9 is a view showing an example of the configuration of an order list creation track table;

FIG. 10 is a view showing an example of the configuration of a playlist table;

FIG. 11 is a view showing an example of the configuration of an order list creation playlist table;

FIG. 12 is a view showing an example of the configuration of an order list;

FIG. 13 is a block diagram showing the internal structure of an order list control means shown in FIG. 1, and the configuration of peripherals for the order list control means;

FIG. 14 is a view showing a selection screen for random playback in the order list; and

FIG. 15 is a view showing another example of the selection screen for random playback in the order list.

### PREFERRED EMBODIMENTS OF THE INVENTION

Hereafter, in order to explain this invention in greater detail, the preferred embodiments of the present invention will be described with reference to the accompanying drawings.

### Embodiment 1

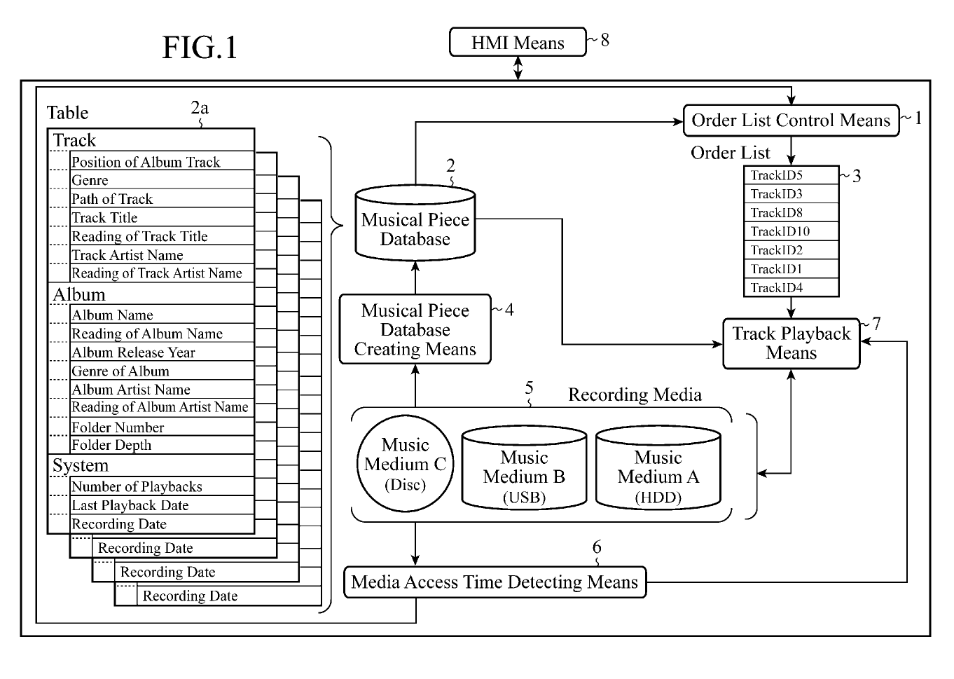

FIG. 1 is a block diagram showing the configuration of a content playback device in accordance with Embodiment 1 of the present invention, and shows a case in which the content playback device in accordance with the present invention is applied to a music playback device that plays back each of musical pieces as a content. As shown in FIG. 1, the content playback device in accordance with Embodiment 1 is provided with an order list control means 1, a musical piece database 2, a musical piece database creating means 4, a media access time detecting means 6, a track playback means 7, and an HMI means 8.

The order list control means 1 searches through the musical piece database 2 for pieces of additional information of music data on the basis of the contents of each table 2a to extract the pieces of additional information, and also creates an order list 3 in which the extracted pieces of additional information of music data are listed. The order list control means controls the playback order in which music data are to be played back by controlling the order of list items in this order list 3.

In the present invention, content data used for playing back and recording a musical piece or a video image, such as audio data, video data, karaoke data, incoming call melody data, podcast data, or mixed data including some of them, the content data including music data (e.g., MP3 music data), are referred to as a content. Furthermore, list data, such as playback order data, showing the playback order or the record order in which contents are to be played back or are recorded are referred to as an order list 3.

The musical piece database (content database) 2 is comprised of tables 2a in each of which pieces of additional information about music data recorded in various types of recording media 5 are registered. Attribution information of music data can be searched for and extracted by the order list control means 1. Each table 2a is table data in which additional information and so on, which are recorded in a recording medium 5 along with corresponding music data, are registered as the attribution information of the music data.

As the additional information of music data, information described in a musical piece data tag incorporated into the music data file can be provided. In a case in which the music data is MP3 (MPEG audio layer 3) data, the additional information includes “artist name, release year, and music name” which are described in an ID3 tag (ID3v1 tag, ID3v1.1 tag, ID3V2 tag, or the like).

More specifically, information including the genre (Genre) of the track (the music data), the title of the track (Track Title), the reading (kana reading) (Track Title YOMI) of the title of the track, the artist name (Artist Name), the reading of the artist name (Artist YOMI) the name of the album (playlist) (Playlist Name), the reading of the playlist name (Playlist YOMI), the track number in the album in which the track is recorded (Tracks), the date when the album was released (Album Year), and the genre (Album Genre) of the album is read.

The musical piece database creating means (a database creating means) 4 creates the musical piece database 2 by associating the additional information of each music data read from each of the recording media 5 with a track path or the like showing the storing position of the music data (track) to register the additional information into the tables 2a. Item information registered into the musical piece database 2 includes, for example, a track ID (Track ID) which is index information about an index to each table which constructs the tables 2a regarding tracks, a track path (Track Path) showing the storing position of each track, a folder number (Folder No) for specifying a folder corresponding to each track in a playlist (album) having a directory structure, and a folder depth (Folder Depth) showing the depth of each folder from the route folder in the directory tree.

As the recording media 5, a music media A which is a hard disk drive (HDD) in which music data are recorded, a music media B which is a USB memory in which music data are recorded, a music media C which is a CD or DVD in which music data are recorded, etc. can be provided. In this case, drive devices and interfaces for use with the music media A to C are also included in the recording media 5.

The media access time detecting means (an access time detecting means) 6 detects an access time required to access music data recorded into each of the music media A to C via the above-mentioned drive devices and the above-mentioned interfaces for use with the recording media 5. For example, the access time required to access music data recorded into the music media C depends upon a pickup (head) of the disk drive device for use with CD or DVD, and the position on the disc where the music data (music file) exists. Furthermore, the access time also depends upon the folder depth of the folder in which the music data exists. As the access time, a media average access time which is the average of the access times which are measured a predetermined number of times, a minimum access time which is the minimum of them, and a maximum access time which is the maximum of them can be provided.

According to the playback order of the tracks (musical pieces) set in the order list 3, the track playback means (content playback means) 7 specifies the music data of the music media which are defined by the track paths to play back each of the tracks. The HMI means 8 is a human-machine interface (HMI) for exchanging information between the content playback device and the user by using a not-shown input unit and a not-shown display unit. For example, the HMI means is controlled by the order list control means 1 and the track playback means 7 to display registration information stored in the musical piece database 2, the information about the order list 3, and the information about the track (music data) currently being played back on the display screen of the display unit. Furthermore, a voice recognition unit can be provided as the HMI means 8 so as to receive information via voice uttered by the user.

By causing a computer to read, for example, a program for configuring the content playback device in accordance with the scope of the present invention to control the operation of the program, the order list control means 1, the musical piece database creating means 4, the media access time detecting means 6, the track playback means 7, and the HMI means 8, which are mentioned above, can be implemented as a concrete means in which software and hardware work in cooperation with each other on the computer.

Furthermore, the musical piece database 2 and the order list 3 can be configured in a storage area of a storage unit (HDD) mounted in the above-mentioned computer, or can be configured in a storage area of an external device with which the order list control means 1, the musical piece database creating means 4, and the track playback means 7 can carryout data communications.

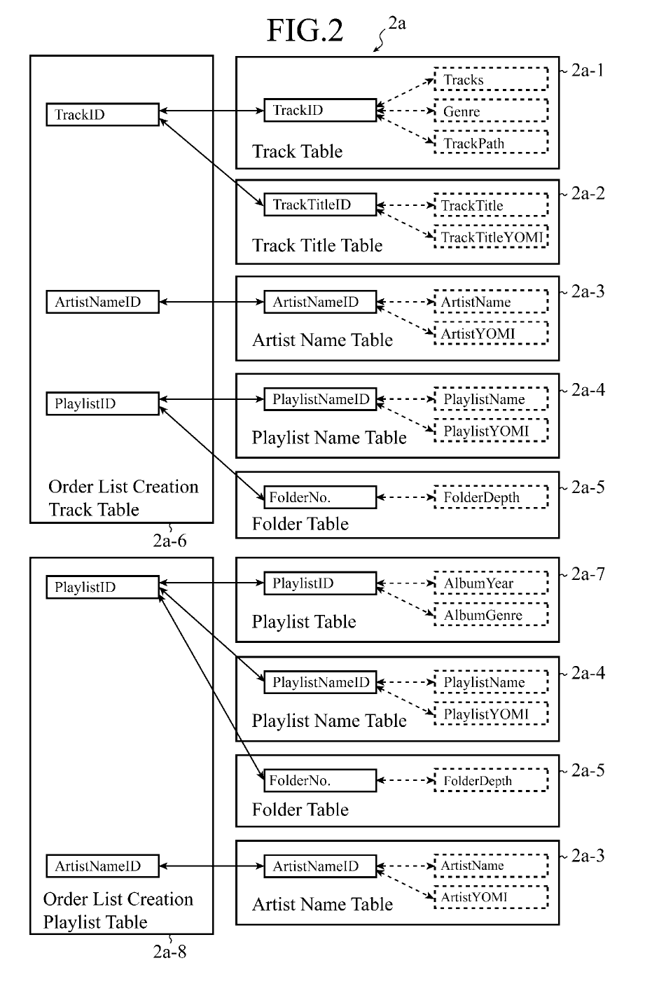

FIG. 2 is a view showing an example of the configuration of the musical piece database shown in FIG. 1. In a case in which the musical piece database 2 are formed on a track-by-track basis, the musical piece database 2 is comprised of, as shown in an upper portion of FIG. 2, a track table 2a-1, a track title table 2a-2, an artist name table 2a-3, a playlist name table 2a-4, a folder table 2a-5, and an order list creation track table 2a-6 with which these tables 2a-1 to 2a-5 are associated as low order layers. The tables 2a-1 to 2a-5 are associated with one another via the following three IDs: a track ID (Track ID), an artist name ID (Artist Name ID), and a playlist ID (Playlist ID), managed by the order list creation track table 2a-6.

The track table 2a-1 manages the additional information other than the titles of the tracks (musical piece titles). In this table, track IDs (Track IDs) each of which is index information about an index to each table which constructs the musical piece database 2, track paths (Track Paths) each showing the storing position of a track, track numbers (Tracks) in the album in each of which a track (musical piece) is recorded, and the genre (Genres) of each of the tracks are registered.

The track name table 2a-2 manages the additional information about the title of each of the tracks (musical piece title). In this table, track title IDs (Track Title IDs) each of which is associated with a track ID so that the track title ID serves as index information about an index to each table which constructs the musical piece database 2, track titles (Track Titles) each specified by a track title ID, and the reading (reading kana) (Track Title YOMI) of the title of each of the tracks are registered.

The artist name table 2a-3 manages the additional information about the artist name of each of the tracks. In this table, artist name IDs (Artist Name IDs) each of which is ID information for specifying an artist name in the musical piece database 2, artist names (Artist Names) each specified by an artist name ID, and the reading (reading kana) (Artist YOMI) of the artist name specified by each of the artist name IDs are registered.

The playlist name table 2a-4 manages the additional information about each playlist (album) name. In this table, playlist name IDs (Playlist Name IDs) each of which is ID information for specifying a playlist name in the musical piece database 2, playlist names (Playlist Names) each specified by a playlist name ID, and the reading (reading kana) (Playlist YOMI) of the playlist name specified by each of the playlist name IDs are registered.

The folder table 2a-5 manages the additional information about each folder corresponding to a playlist. In this table 2a-5, folder numbers (Folder No) each for specifying a folder corresponding to a playlist, and the depth (Folder Depth) of each folder showing the depth (hierarchical layer depth) of the folder hierarchically managed in the directory structure from the route folder (zero hierarchical layer (depth=0)) are registered.

The order list creation track table 2a-6 manages the tracks (musical pieces), and are table data for creating the order list in which the music data to be played back are listed on a track-by-track basis. In this table, the track IDs, the artist name IDs, and the playlist IDs are registered. The track table 2a-1 and the track title table 2a-2 are associated with the track IDs managed by the order list creation track table 2a-6.

The artist name table 2a-3 is associated with the artist name IDs managed by the order list creation track table 2a-6. The playlist name table 2a-4 and the folder table 2a-5 are associated with the playlist IDs managed by the order list creation track table 2a-6.

Thus, the tables 2a-1 to 2a-5 into which the pieces of additional information of the music data are grouped are associated with the three pieces of ID information registered into the order list creation track table 2a-6 respectively. Accordingly, on the basis of the information items in the tables 2a-1 to 2a-5, information which is a search object can be searched for and a specification of the information can be made. Furthermore, even if a change is made to the additional information of music data, the change of the additional information can be handled by sequentially specifying corresponding tables on the basis of the pieces of ID information stored in the order list creation track table 2a-6.

In addition, in a case in which the musical piece database 2 are formed on an album-by-album (playlist-by-playlist) basis, the musical piece database 2 is comprised of, as shown in a lower portion of FIG. 2, an artist name table 2a-3, a playlist name table 2a-4, a folder table 2a-5, a playlist table 2a-7, and an order list creation playlist table 2a-8 with which these tables 2a-3 to 2a-5 and 2a-7 are associated as low order layers. The tables 2a-3 to 2a-5 and 2a-7 are associated with one another via the following two types of IDs: playlist IDs and artist name IDs managed by the order list creation playlist table 2a-8.

The playlist table 2a-7 manages the additional information other than playlist (album) names. In this table, playlist IDs (Playlist ID) each of which is ID information for specifying a playlist in the musical piece database 2, the year (Album Year) in which each album (playlist) was released, and the genre (Album Genre) of each album are registered.

The order list creation playlist table 2a-8 manages the playlists (albums), and is table data for creating the order list in which the music data to be played back are listed on a per-playlist basis. The playlist IDs and the artist name IDs are registered into this table.

The playlist table 2a-7, the playlist name table 2a-4, and the folder table 2a-5 are associated with the playlist IDs managed by the order list creation playlist table 2a-8. The artist name table 2a-3 is associated with the artist name IDs managed by the order list creation playlist table 2a-8.

The tables 2a-3 to 2a-5 and 2a-7 into which the pieces of additional information of the music data are grouped are associated with the two pieces of ID information registered into the order list creation playlist table 2a-8 respectively. Accordingly, on the basis of the information items in the tables 2a-3 to 2a-5 and 2a-7, information which is a search object can be searched for and a specification of the information can be made from the additional information of the music data. Furthermore, even if a change is made to the additional information of music data, the change of the additional information can be handled by sequentially specifying corresponding tables on the basis of the pieces of ID information stored in the order list creation playlist table 2a-8.

Next, the operation of the content playback device will be explained.

### (1) A Process of Creating the Musical Piece Database

First, when a folder which is associated with music data recorded into the HDD (music medium A) is selected by using the HMI means 8, the USB memory (music medium B) is connected to the USB connector, or the CD or DVD (music medium C) is mounted to the disk drive device, the content playback device places the music medium A, B, or C in an accessible state in which the music medium can be accessed by the musical piece database creating means 4.

When the music medium A, B, or C is placed in the accessible state, the musical piece database creating means 4 extracts the musical piece information tags (e.g., the ID3 tags of MP3 data) incorporated into the music data files currently recorded into the music medium A, B, or C, and searches through the described information to read the additional information described in each of the musical piece information tags. Furthermore, the musical piece database creating means 4 extracts information including the track paths, the folder numbers, the folder depths, etc., from the library information about the music data whose musical piece information tags have been read.

When placing the music medium A, B, or C in the accessible state, the musical piece database creating means 4 can display a selection screen in which the music names specified by the musical piece information tags read from the one of the music media A to C are listed on the display screen of the display unit to allow the user to select musical pieces from which the user desires to form the database by using the input unit.

Next, the musical piece database creating means 4 creates the musical piece database 2 by categorizing the pieces of information read as mentioned above into parts respectively corresponding to the information items of the tables 2a to register them. An explanation of the musical piece database 2 will be made with reference to the example shown in FIG. 2. The information about the tracks (musical pieces) among the pieces of information read from the musical piece information tags is grouped into the tables 2a-1 and 2a-2 associated with the order list creation track table via the track IDs, the information about the artist names is grouped into the table 2a-3 associated with the order list creation track table via the artist name IDs, and the information about the playlists is grouped into the tables 2a-4 and 2a-5 associated with the order list creation track table via the playlist IDs. These pieces of information are then registered.

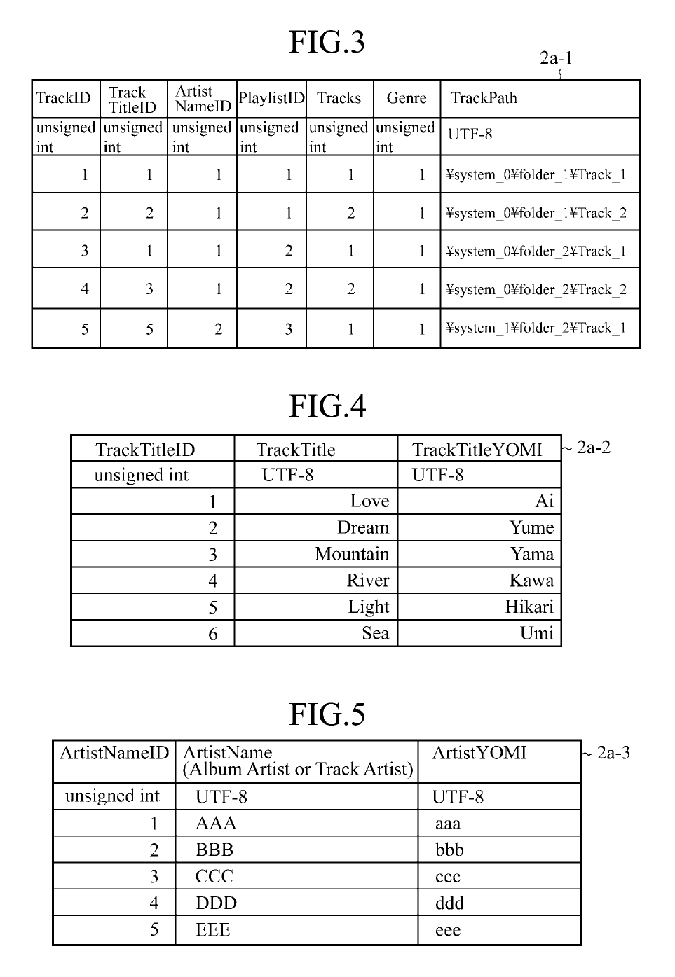

In this case, because each track ID of the order list creation track table 2a-6 is associated with a track ID of the track table 2a-1, as shown by an arrow in FIG. 2, the track table 2a-1 is associated with the track title IDs (Track Title IDs) in the track title table 2a-2. Furthermore, because each track ID is associated with a playlist ID in the order list creation track table 2a-6, a track ID, a track title ID, an artist name ID, a playlist ID, a track number (Tracks), a genre, and a track path are associated with one another in the track table 2a-1, as shown in FIG. 3.

The content playback device can know from this table 2a-1 that, for example, the information corresponding to a track ID=4 includes a track title ID=3, a track number=2, a genre=1, and a track path=¥system_{—}0¥folder_{—}2¥Track_{—}2. The track table 2a-1 has the attribute information about each track (musical piece) and the information about the position (storing position) of each track.

Furthermore, the track title table 2a-2 constructs table data in which track name IDs, track titles, and track title readings are registered as shown in FIG. 4. Character information which constructs each table is expressed by using, for example, UTF-8 which is a unicode character coding method.

The content playback device can know from this table 2a-2 that, for example, the information corresponding to a track name ID=3 includes a track title=“mountain” and a track title reading=“yama”. In the track name table 2a-2, the track titles are registered uniquely without being identical to one another. However, even different tracks can have the same title. Therefore, as the track title IDs of different tracks, the same track title ID can be registered.

Similarly, the artist name table 2a-3 constructs table data in which artist name IDs, artist names (album artist names or track artist names), and artist name readings are registered as shown in FIG. 5. The content playback device can know from this table that. for example, the information corresponding to an artist name ID=1 includes an artist name=“AAA” and an artist name reading=“aaa”. In this table 2a-3, the artist names are registered uniquely without being identical to one another. However, even different artists can have the same family and personal name. Therefore, as the artist name IDs of different artists, the same artist name ID can be registered.

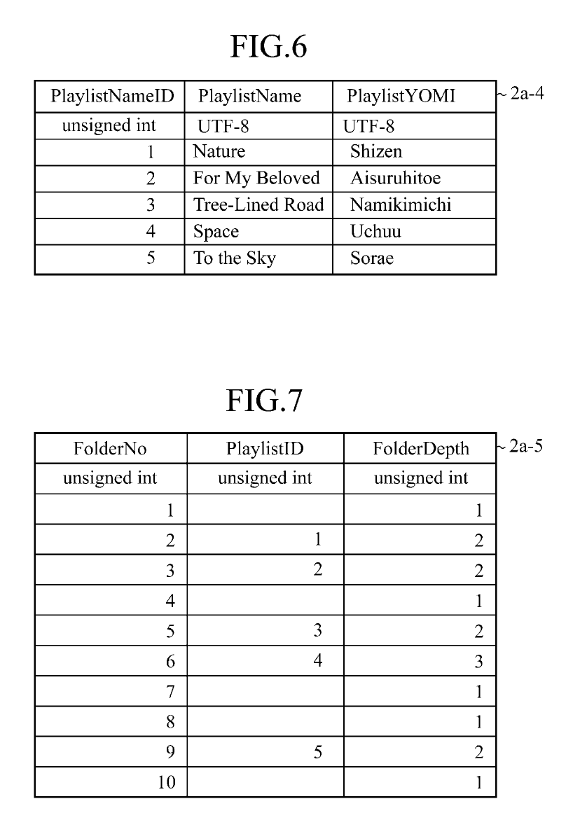

Furthermore, the playlist name table 2a-4 constructs table data in which playlist name IDs, playlist names, and playlist name readings are registered as shown in FIG. 6. The content playback device can know from this table that the information corresponding to a playlist ID=3 includes a playlist name=“a tree-lined road” and a playlist name reading=“namikimichi”. In this table 2a-4, the playlist names are registered uniquely without being identical to one another. However, even different playlists can have the same name. Therefore, as the playlist name IDs of different playlists, the same playlist name ID can be registered.

In addition, as shown by arrows in FIG. 2, a playlist name ID in the playlist name table 2a-4 and a folder number in the folder table 2a-5 are associated with a playlist ID in the order list creation track table 2a-6, and the folder table 2a-5 is associated with the playlist name IDs in the playlist name table 2a-4. Accordingly, as shown in FIG. 7, in the track table 2a-1, a folder number, a playlist ID, and the depths of a folder are associated with one another.

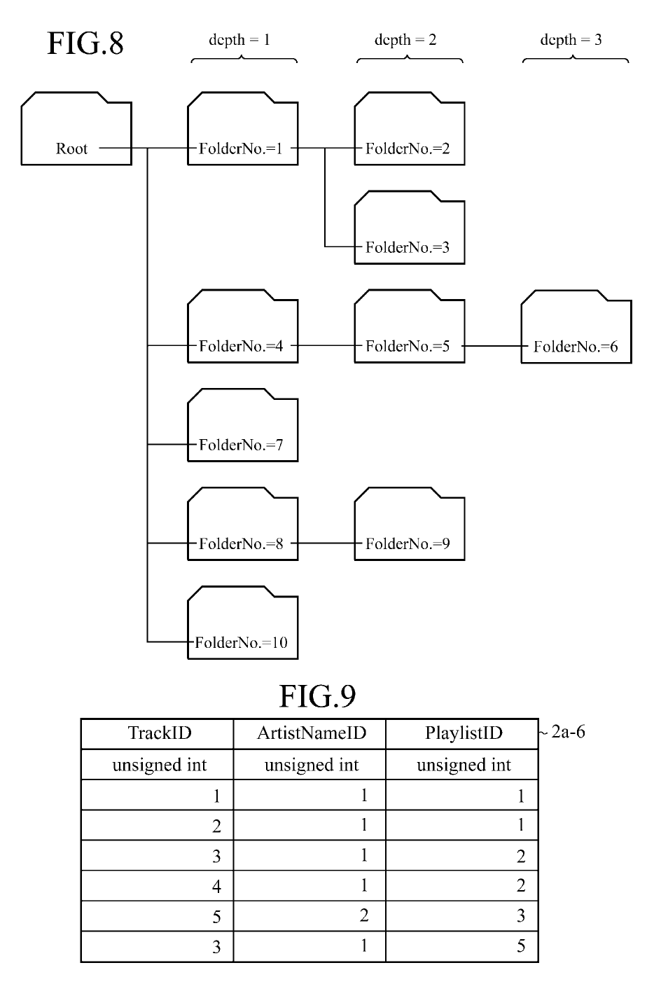

FIG. 8 is a view showing a hierarchical relationship among folders with each of which music data are associated. The folder table 2a-5 shown in FIG. 7 is obtained by structurizing the relationship shown in FIG. 8. The content playback device can know from the folder table 2a-5 that the information corresponding to a folder number=2 includes a playlist ID=1 and a folder depth=2. By thus referring to the registered contents of the folder table 2a-5, the content playback device can know the hierarchical relationship among the folders, the positions of the folders, and that each of the folders includes tracks (musical pieces). In other words, the content playback device can determine whether each of the folders corresponds to a playlist.

After creating the tables 2a-1 to 2a-5 in the above-mentioned way, the musical piece database creating means 4 establishes music data associations by using the track IDs, the artist name IDs, and the playlist IDs, and registers these pieces of ID information into the order list creation track table 2a-6. Accordingly, in the musical piece database 2, the tables 2a-1 to 2a-6 are associated with one another via the above-mentioned three pieces of ID information.

By referring to the order list creation track table 2a-6, the content playback device can know that the information corresponding to a track ID=3 includes an artist name ID=1 and a playlist ID=2 as shown in FIG. 9. Furthermore, by referring to the track table 2a-1 and the order list creation track table 2a-6 shown in FIG. 3, the content playback device can know, via the track ID, that the information corresponding to a track name=1 includes a track number=1, a genre=1, and a track path=¥system_{—}0¥folder_{—}2¥Track_{—}1.

In addition, by referring to the artist name table 2a-3 and the order list creation track table 2a-6 shown in FIG. 5, the content playback device can recognize, via the artist name ID, an artist name=“AAA” and an artist name reading=“aaa”. Furthermore, by referring to the playlist name table 2a-4 and the order list creation track table 2a-6 shown in FIG. 6, the content playback device can know, via the playlist ID, that the information corresponding to the playlist name ID=2 includes a playlist name=“For my beloved” and a playlist name reading=“aisuruhitoe”.

In contrast, in the case in which the musical piece database is formed on an album-by-album (playlist-by-playlist) basis, the musical piece database creating means 4 categorizes the information regarding the playlists, among the pieces of information read from the musical piece information tags, into the tables 2a-7, 2a-4, and 2a-5 associated with the order list creation playlist table via the playlist IDs, and also categorizes the information about the artist names into the table 2a-3 associated with the order list creation playlist table via the artist name IDs to register them.

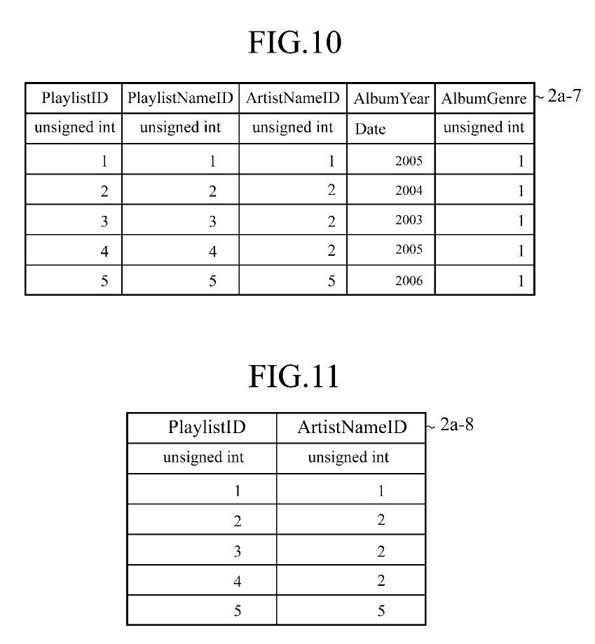

In this case, as shown by arrows in FIG. 2, because each playlist ID in the playlist table 2a-7 is associated with a playlist ID in the order list creation playlist table 2a-8, the playlist table 2a-7 is associated with the playlist name IDs (Playlist Name ID) in the playlist name table 2a-4. Furthermore, because each playlist ID is associated with an artist name ID in the order list creation playlist table 2a-8, a playlist ID, a playlist name ID, an artist name ID, an album release year, and an album genre are associated with one another in the playlist table 2a-7, as shown in FIG. 10.

In the example of FIG. 10, the content playback device can know from the playlist table 2a-7 that the information corresponding to a playlist ID=2 includes a playlist name ID=2, an artist name ID=2, an album release year=2004, and an album genre=1. Thus, each playlist's attribute information is registered in the playlist table 2a-7.

After creating the tables 2a-3 to 2a-5 and 2a-7 in the above-mentioned way, the musical piece database creating means 4 establishes music data associations by using the playlist IDs and the artist name IDs, and registers these pieces of ID information into the order list creation playlist table 2a-8. Accordingly, in the musical piece database 2, the tables 2a-3 to 2a-5 and 2a-7 are associated with one another via the above-mentioned two pieces of ID information.

By referring to the order list creation playlist table 2a-8, the content playback device can know that a playlist ID=4 corresponds to an artist name ID=2, as shown in FIG. 11. Furthermore, by referring to the playlist table 2a-7 and the order list creation playlist table 2a-8 shown in FIG. 10, the content playback device can know, via the playlist ID, that the information corresponding to a playlist name ID=4 includes an album release year=2005 and an album genre=1.

In addition, by referring to the artist name table 2a-3 and the order list creation playlist table 2a-8 shown in FIG. 5, the content playback device can recognize, via the artist name ID, that an artist name reading corresponding to an artist name=“BBB” is “bbb”. Furthermore, by referring to the playlist name table 2a-4 and the order list creation playlist table 2a-8 shown in FIG. 6, the content playback device can know, via the playlist name ID, that a playlist name reading corresponding to a playlist name=“space” is “uchuu”.

Thus, in the musical piece database 2, the additional information of music data recorded into each of the various recording media 5 is grouped and registered into the various tables of the table set 2a which are associated with one another via the three pieces of ID information including the track IDs, the artist name IDs, and the playlist IDs. As a result, the additional information of music data recorded into each of the various recording media 5 is managed systematically in the musical piece database 2 without being dependent upon the types of the recording media 5.

Furthermore, when making a specification of information which is a search object, making a search for information which is a search object, or performing a process of registering information into the order list 3 in the musical piece database 2, the content playback device can carry out the above-mentioned process easily without being aware of the types of recording media 5 by following the associations among the pieces of information with reference to the items of the various tables which construct the table set 2a. Even if a change is made to the additional information of music data, the content playback device has only to change the associated information of the music data in the tables.

### (2) A Process of Creating the Order List

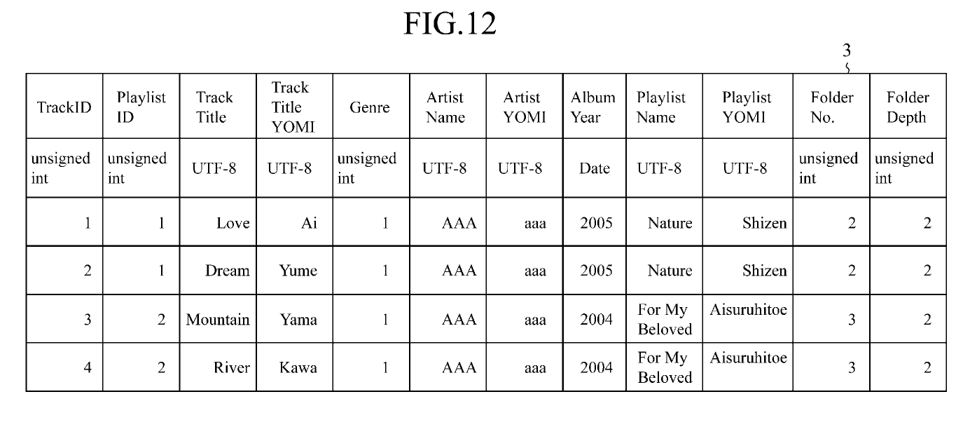

By combining the tables 2a-1 to 2a-5 and 2a-7 as shown in FIGS. 3 to 8 and 10, the order list control means 1 creates the order list 3. The order list 3 has a list structure as shown in FIG. 12, and is a set of pieces of information about the tracks or playlist corresponding to the music data to be played back.

In the example shown in FIG. 12, track IDs are indexes to the various tables 2a-1 to 2a-5 into which the pieces of information about the tracks (musical pieces) are registered, and playlist IDs are indexes to the various tables 2a-3 to 2a-5 and 2a-7 into which the pieces of information about the playlist (album) are registered.

### (3) A Process of Setting the Playback Order in the Order List (Random Playback)

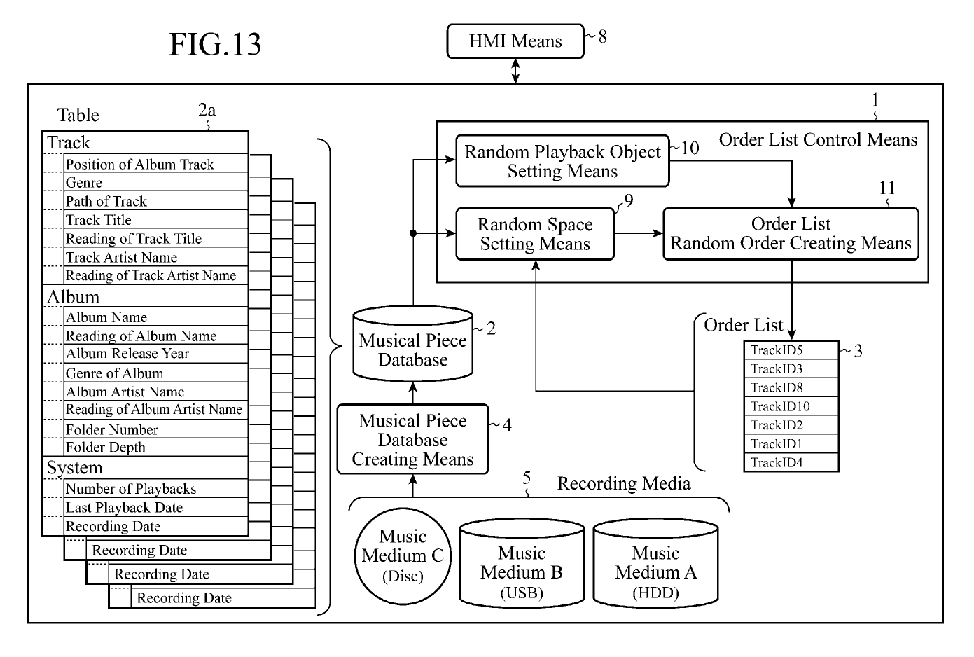

FIG. 13 is a block diagram showing the internal structure of the order list control means shown in FIG. 1, and the configuration of peripherals for the order list control means. In the figure, among the components of the order list control means 1, only components for setting the track playback order of the order list 3 to a random one are selectively shown. In FIG. 13, the order list control means 1 is provided with, as the components for setting the track playback order of the order list 3 to a random one, a random space setting means 9, a random playback object setting means 10, and an order list random order creating means 11.

The random space setting means (region setting means) 9 inquires of the musical piece database 2 about the attribute items in which the tracks registered into the order list 3 are included, and sets a space determined by all or part of the information corresponding to the above-mentioned attribute items in the musical piece database 2 as an object space for random playback. For example, the random space setting means sets, as the object space for random playback, a space in which pieces of attribute item information including a folder structure, a music genre, and a release year are defined as its coordinate axes.

The random playback object setting means (object setting means) 10 inquires of the musical piece database 2 about the attribute items in which the tracks registered into the order list 3 are included, and sets the attribute items to be arranged in a random order in the order list 3. The order list random order creating means (order creating means) 11 arranges the pieces of additional information belonging to the object space for random playback which is set by the random space setting means 9 and corresponding to the attribute items set as the objects to be arranged in the random order by the random playback object setting means 10 in a random playback order in the order list 3 by using random numbers or the like.

Next, the details of the process of setting random playback in the order list will be explained.

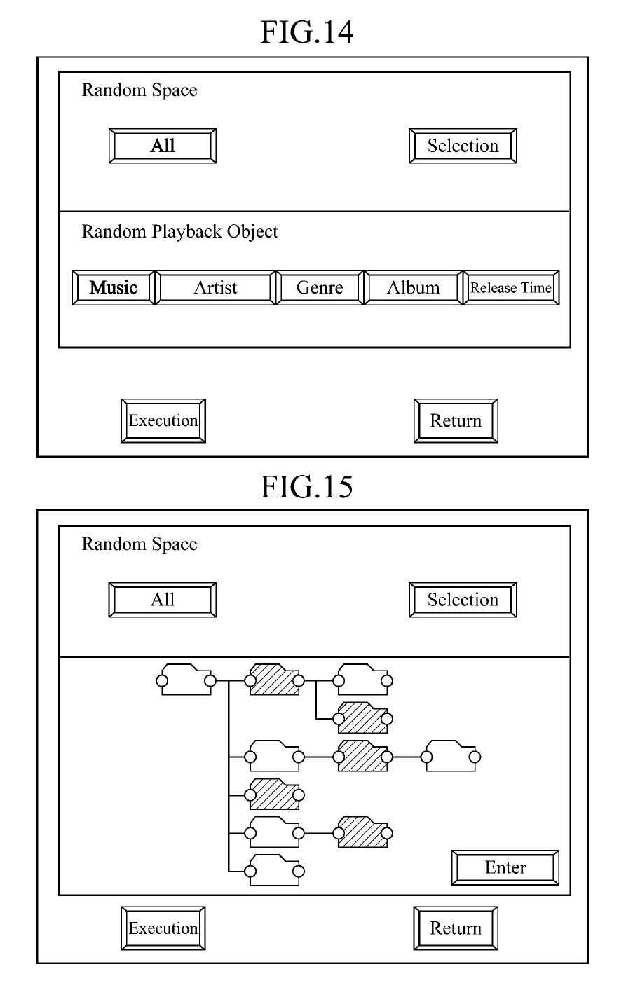

First, either the random space setting means 9 or the random playback object setting means 10 displays a random playback selection screen as shown in FIG. 14 on the display unit. In this case, by clicking and selecting either one of an “all” button and a “select” button disposed in a random space frame as shown in FIG. 14, the user can set either all the tracks registered into the order list 3 or the tracks selected from the order list 3 as a region for random playback which the user desires to cause the content playback device to randomly play back. In the example of FIG. 14, the “all” button is selected, and information space defined by all the pieces of item information registered into the order list 3 is selected as the region for random playback.

When the “select” button disposed in the random space frame as shown in FIG. 14 is selected, the random space setting means 9 displays a selection screen which enables the user to select the pieces of item information defining the information space which is the object to be randomly played back, and sets the information space defined by the attribute item information selected by using a not-shown input unit as the region for random playback. The item information which defines the information space set as the region for random playback is outputted from the random space setting means 9 to the order list random order creating means 11.

When the user then clicks and selects a button disposed in a random playback object frame in FIG. 14 and showing an attribute music name item (e.g., “musical piece”), the random playback object setting means 10 sets, as an object to be played back in the random order, the attribute item “musical piece” in the information space set by the random space setting means 9, and outputs it to the order list random order creating means 11. In the example of FIG. 14, one of the attribute items “music name”, “artist name”, “genre”, “album name”, and “release time” can be selected as objects to be randomly played back.

Furthermore, when the random space setting means 9 sets the total range of the order list 3 as the objects to be randomly played back, and when a part of all the items of the additional information is not registered into the order list 3, the random space setting means 9 can inquire of the musical piece database 2 about the part which is not registered into the order list 3 and output the part to the random playback object setting means 10, and the random playback object setting means 10 can display a selection screen which enables the user to select, as objects to be randomly played back, additional information items including the above-mentioned items on the display unit. In addition, the random playback object setting means 10 can inquire of the musical piece database 2 about items which are not registered into the order list 3 to display a selection screen which enables the user to select, as objects to be randomly played back, additional information items including the items on the display unit.

After the region and the objects to be played back in the random order are thus selected, the order list random order creating means 11 determines the playback order of the tracks corresponding to the selected region and objects on a random basis by using a random number or the like to sort the playback order of the order list 3.

In the case of FIG. 14, all the tracks registered into the order list 3 as the region are selected, and music names are selected as the objects. In the determination of the playback order in this case, the random playback order is set on the basis of the music names of the order list 3. This process can be expressed in a database language as follows.
SELECT *
   FROM OrderList
   ORDER BY TrackTitleName RAND( )

Instead of displaying a plurality of attribute items in such a way that each of them can be selected as objects to be randomly played back as shown in FIG. 14, the hierarchical structure of the folders can be displayed on a selection screen by using information about the folder numbers registered into the order list 3 and the depths of the folders, and a playlist included in each of the folders can be selected as an object to be randomly played back, as shown in FIG. 15.

In the example of FIG. 15, diagonally shaded folders are selected as the region to be randomly played back, and the order list random order creating means 11 determines the tracks of the playlists included in the selected folders as objects to be randomly played back to determine the random playback order, and sorts the playback order of the order list 3.

### (4) A Process of Playing Back Contents

The order list 3 in which the playback order is set is stored in a not-shown memory disposed in the order list control means 1. When a playback request is made by the user via the HMI means 8, the track playback means 7 inputs the information about each of the tracks in the playback order of the order list 3, searches through the musical piece database 2 with the track ID corresponding to the track in question to read the track path from the track table 2a-1, and stores the track path therein. This process can be expressed in a database language as follows.
SELECT

TrackTable. TrackPath TrackPath
FROM TrackTable, Orderlist
WHERE Orderlist.rowid=1
AND Orderlist.TrackID=TrackTable.TrackID;

The track playback means 7 accesses the music data in the corresponding recording medium 5 on the basis of the track paths which the track playback means has acquired in the above-mentioned way, and carries out the playback process. For example, in the case of the order list 3 shown in FIG. 12, the track playback means sequentially plays back the tracks starting from the first track in the list whose track name is “love”. At this time, the track playback means 7 can display the additional information and playback state of the music data currently being played back on the display screen of the display unit.

As mentioned above, the content playback device in accordance with this Embodiment 1 selects a region of pieces of additional information about contents to be played back in a random order in the order list 3, and also sets pieces of item information of additional information to be arranged in the random order in the order list 3 within the set region of pieces of additional information. The content playback device then arranges the pieces of additional information in the order list 3 in the random playback order on the basis of the pieces of item information which are set within the above-mentioned region of pieces of additional information so as to play back content data recorded into the recording media 5. By doing in this way, the content playback device can systematically handle the plural types of recording media 5, and can control the playback of content data, such as musicals piece, in a random order without being aware of the types of recording media 5.

In above-mentioned Embodiment 1, the case in which music data, such as MP3 (MPEG audio layer 3) data, are handled is explained, though the present invention is not limited to this example. For example, even in a case of content data about a content, such as a musical piece or a video image, including audio data, video data, karaoke data, incoming call melody data, podcast data, or mixed data including some of them, the content playback device can handle the content data similarly.

### INDUSTRIAL APPLICABILITY

As mentioned above, the content playback device in accordance with the present invention is configured in such a way as to select a region of pieces of additional information about contents to be played back in a random order in an order list, also sets pieces of item information of additional information to be arranged in the random order in the order list within the set region of pieces of additional information, and then arranges the pieces of additional information in the random playback order in the order list on the basis of the pieces of item information which are set within the above-mentioned region of pieces of additional information so as to play back content data recorded into recording media. Because the content playback device in accordance with the present invention can systematically handle plural types of recording media, and can control the playback of content data, such as musicals piece, in a random order without being aware of the types of recording media, the content playback device is suitable for use as a music playback device that plays back- each of musical pieces as a content, and so on.

1. A content playback device comprising:
a database creating unit for extracting pieces of additional information each for specifying a content from a plurality of types of recording media in which content data and the additional information for specifying the content are recorded to create a content database in which path information showing a recording place of said additional information and said content data is registered for each content;
a region setting unit for selecting a region of pieces of additional information of contents to be played back in a random order in an order list in which the pieces of additional information extracted from said content database are listed;
an object setting unit for setting pieces of item information of said pieces of additional information which are to be arranged in said order list in the random order within said region of pieces of additional information set by said region setting unit;
an order creating unit for arranging said pieces of additional information in said order list in the random playback order within said region of pieces of additional information set by said region setting unit on a basis of the pieces of item information set by said object setting unit; and
a content playback unit for playing back content data recorded in said recording media in the playback order of said order list on a basis of path information acquired from said content database.

2. The content playback device according to claim 1 wherein the region setting unit displays a selection screen which enables a selection of all or part of the pieces of additional information registered into the order list as the region of pieces of additional information of contents to be played back in a random order on the display unit, and accepts the selection of the region of pieces of additional information according to this selection screen, the object setting unit displays a selection screen which enables a selection of the pieces of item information of said pieces of additional information which are to be arranged in said order list in the random order within said region of pieces of additional information on said display unit, and accepts the selection of the pieces of item information of the additional information according to this selection screen, and the order creating unit arranges said pieces of additional information in said order list in the random playback order on a basis of the region of pieces of additional information and the pieces of item information which are selectively inputted.

3. The content playback device according to claim 2 wherein the region setting unit displays a hierarchical relationship among folders corresponding to the pieces of additional information registered into the order list on the selection screen, and accepts the selection of the region of pieces of additional information for each of said folders.

4. A program that causes a computer to operate as the content playback device according to claim 1.
